(19) United States
(12) Patent Application Publication
(10) Pub. No.: US 2009/0261574 A1
(43) Pub. Date: Oct. 22, 2009

(54) EXHAUST SYSTEM AND METHOD FOR JOINING COMPONENTS OF AN EXHAUST SYSTEM

(76) Inventors: Alfred Blueml, Landsberg (DE); Hongjian Cui, Meitingen (DE)

Correspondence Address: PAMELA A. KACHUR, 950 W 450 S, BLDG. 4, COLUMBUS, IN, 47201, US

(21) Appl. No.: 11/573,009

(22) PCT Filed: Jul. 4, 2005
(86) PCT No.: PCT/EP05/07191

§ 371 Date: Jan. 10, 2008

(30) Foreign Application Priority Data
Aug. 5, 2004 (DE) 10 2004 038 099.6

(51) Int. Cl. F16L 13/02; B23K 1/002

(52) U.S. Cl. 285/21.1; 219/616

(57) ABSTRACT

An exhaust gas system with a first component and a second component is characterized in that an induction solder joint is present between the two components (10, 12). In a method of connecting a first component of a vehicular exhaust gas system with a second component provision is made that two components, which are put together and provided with a high temperature solder material (20), are heated up in the region of the solder material by means of an inductor (28) to a temperature which lies above the melting temperature of the solder material (20).

The invention relates to an exhaust gas system, in particular for a motor vehicle, as well as to a method of connecting two components of an exhaust gas system in particular for a motor vehicle.

The components which are to be connected with each other are in particular the pipes of the exhaust gas system, which conduct the exhaust gas flow from the outlet manifold to a catalytic converter or a silencer, for example. With regard to the high temperatures and the high dynamic stresses to which the components of an exhaust gas system are exposed, such components hitherto always have been connected through a weld seam. In fact, there arise some disadvantages if the components of an exhaust gas system are welded to each other. For one thing, for carrying out the method comparatively much floor space is needed for an automatic welding machine or a welding robot, for instance. In both cases, the components which are to be welded to each other have to be moved relative to the welding head. This is why complex devices are required for the fixation of the components to be welded to each other, accompanied by high dynamic loading. These devices have a relatively high space requirement in the welding cabin and for their storage. Moreover, very many devices have to be kept in stock because for each design a new device is required as a general rule. In addition it has turned out that a weld seam has a detrimental effect on the strength. Specifically, the weld seam results in an abrupt change in cross-section of the connected components and correspondingly in an alteration of the rigidity of the exhaust gas system, giving rise to a stress concentration in the region of the weld seam. It is in particular the region of the weld seam root or undercut which possibly is the origin for the formation of cracks. Finally, the heat which is introduced into the two components during welding results in a welding-provoked distortion which after welding has to be individually corrected on a straightening bench, if necessary. Despite of all these disadvantages it has generally become accepted in the field of exhaust gas systems to weld components to each other; it is the prevailing opinion in prior art that this is the only way to create a connection of components which withstands the occurring temperature stresses and dynamic stresses.

It is the object of the invention to connect two components of an exhaust gas system in a way other than by welding in order to avoid the above-mentioned disadvantages during welding.

For solving this problem there is provided according to the invention an exhaust gas system which comprises a first component and a second component and is characterized in that an induction solder joint is present between the two components. This problem is also solved by a method of connecting a first component of a vehicular exhaust gas system with a second component, in which the two components, which are put together and provided with a high temperature solder material, are heated up in the region of the solder material by means of an inductor to a temperature which lies above the melting temperature of the solder material. The invention is based on the surprising cognition that contrary to the prejudices prevailing among experts a high temperature soldered connection withstands the stresses which act on a vehicular exhaust gas system. Up to now it was generally assumed that a soldered connection is out of the question, merely because of the temperatures which may occur in the components of the exhaust gas system and possibly lie above 600° C. The maximum allowable operating temperature of soldered components was generally seen to be at approximately 200° C., even if a high temperature solder was used (see for instance the draft of the bulletin DVS 938-2 “Electric Arc Soldering” (Lichtbogenschweiβen) of the German Association for Welding Technology (Deutscher Verband für Schweiβtechnik) of October 2002, in which an operating temperature for soldered connections for exhaust gas systems is indicated with 180° C. at most, and an employment of soldered connections with temperatures of more than 180° C. is explicitly not recommended). The invention ignores this prejudice because the Applicant has found out in experiments that soldered components can be exposed even for longer periods of time to temperatures of more than 600° C. without any impairment of the mechanical stability of the soldered connection. The fact that after solidification of the solder material a re-melting temperature arises which is higher than the initial melting temperature, additionally has a favorable effect on the high temperature strength of the soldered connection. The reason for this is not conclusively clarified yet.

One reason could lie in the fact that certain by-alloys evaporate during melting. A further reason could be the diffusion of atoms of the base material into the solder material.

Employing a soldered connection instead of a welded connection entails a number of advantages. For one thing, the two components can be connected with each other with a lower expenditure and smaller space requirement as is the case with employing a welding method. It is not required that a robot travels around the two components in the region of their connection in circumferential direction. Instead of that, it is possible to accommodate the connection region between the two components in a compact shielding gas chamber. Up to a particular temperature which is lower than the operating temperature occurring in exhaust gas systems, the dynamic strength of the soldered connection is higher than with a welded connection, because no abrupt changes in rigidity are produced. It is also possible to form the two components with a smaller wall thickness if they are soldered instead of welded to each other. That is to say, the wall thickness of components which are to be welded to each other has to be designed in the field of exhaust gas system in some cases not in view of the required strength of the components, but rather with regard to the risk of a melting-through during welding. This risk will be dropped if the two components are soldered with each other, so that in future only the occurring stresses will be relevant for dimensioning. Finally it is possible to replace flange and clamping piece connections with a soldered connection. Due to their high assembly expenditure and because of problems in terms of leak tightness, such connections more and more turn out to be disadvantageous, so that one proceeds to produce all components of the exhaust gas system in the form of an integral joint.

According to a preferred embodiment of the invention provision is made that one of the components has a support surface for solder. This makes it possible to arrange the solder near the solder gap, so that the solder material is drawn into the solder gap by capillary forces as soon as it is molten. In this process, the support surface prevents that the solder material flows away from the solder gap toward other regions of the component. On the one hand, the solder material would be undesirable at this place because of visual reasons, and on the other hand this solder material would not be available any more for the actual soldered connection.

The support surface on the component can be formed with low expenditure by a surrounding bead on which the solder ring may be arranged.

According to another alternative embodiment provision can be made to arrange a solder support in the region of the solder joint, which solder support comprises the support surface for the solder material. This embodiment has the advantage that the component itself does not have to be deformed in order to form the support surface. It will be preferred that the solder support consists of a material which is electrically non-conductive, for instance of a ceramic material. This involves that during the induction soldering process the solder support will not be inductively heated, so that the solder material is not bonded to the solder support. Thus, the latter can be removed without any problems when the two components are soldered to each other.

According to another alternative embodiment of the invention a runout region is provided between the two components, which runout region receives excessive solder without the latter having made a connection with the two components. So the runout region acts in the nature of an overflow container which will be filled when the solder gap is completely filled up with the solder material. Here it is provided that the runout region during soldering is not heated up to soldering temperature, so that the solder material begins to solidify as soon as it enters the runout region. This guarantees that the solder material will not escape on the side facing away from the solder gap, resulting in undesired solder drops in the interior of the two components. Such a solder drop could cause damages in the interior during operation of the exhaust gas system.

Advantageous embodiments of the invention will be apparent from the sub-claims.

The invention will be described in the following on the basis of various embodiments which are illustrated in the attached drawings in which:

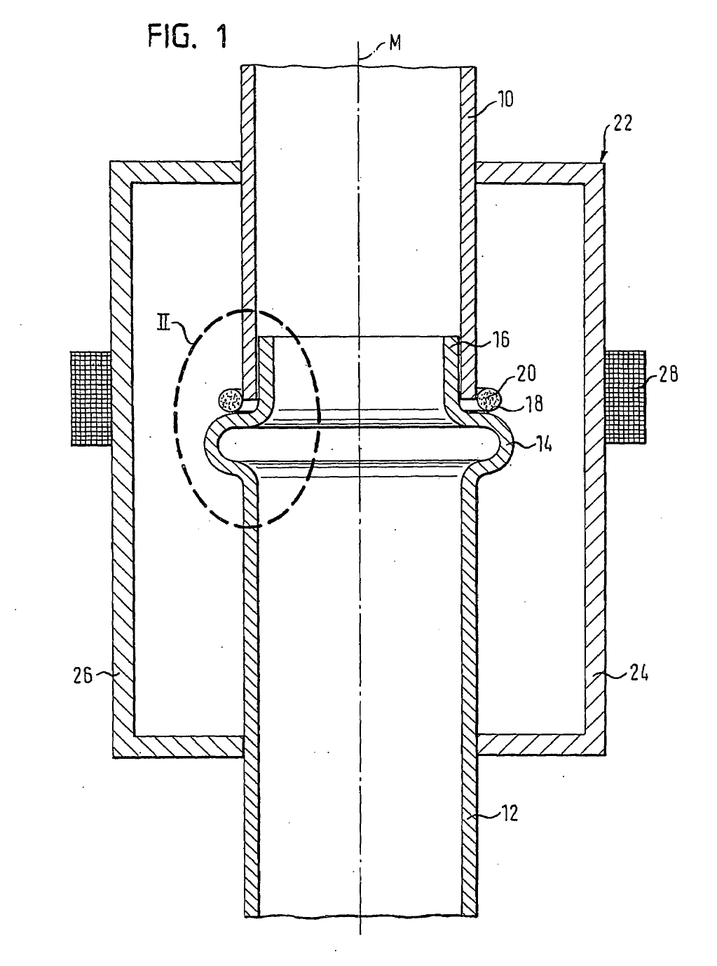

FIG. 1 schematically shows according to a first embodiment of the invention two components which are to be soldered to each other, arranged in a soldering device;

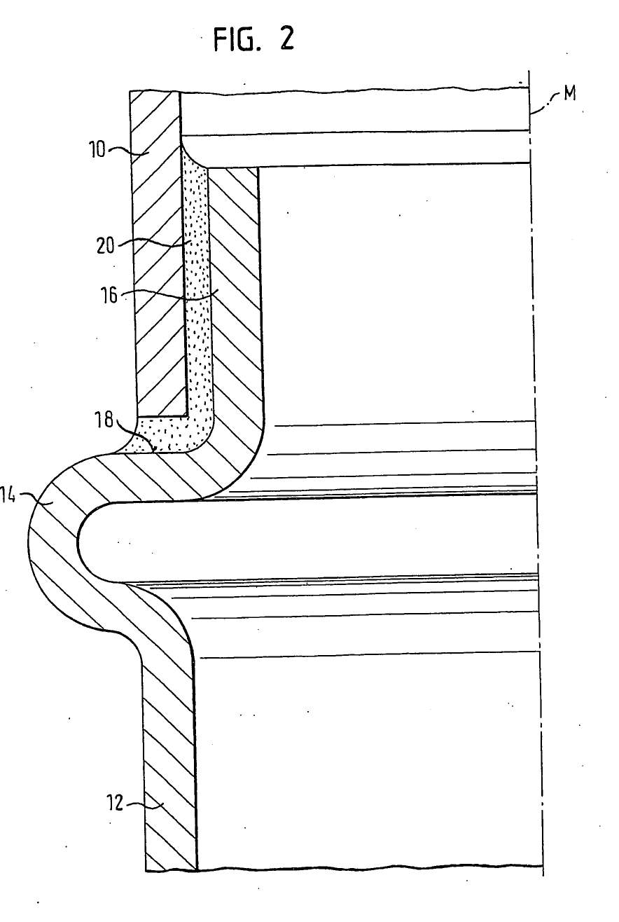

FIG. 2 shows on an enlarged scale the detail II of FIG. 1, after the two components have been soldered to each other;

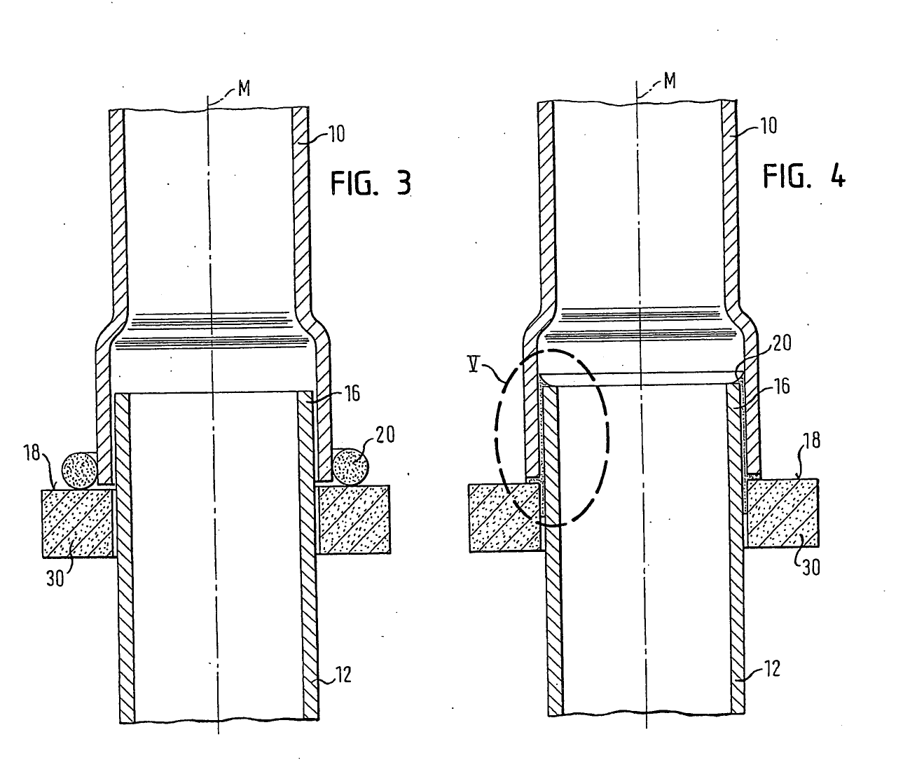

FIG. 3 schematically shows according to a second embodiment of the invention two components which are to be soldered to each other;

FIG. 4 shows the two components of FIG. 3 in the soldered state;

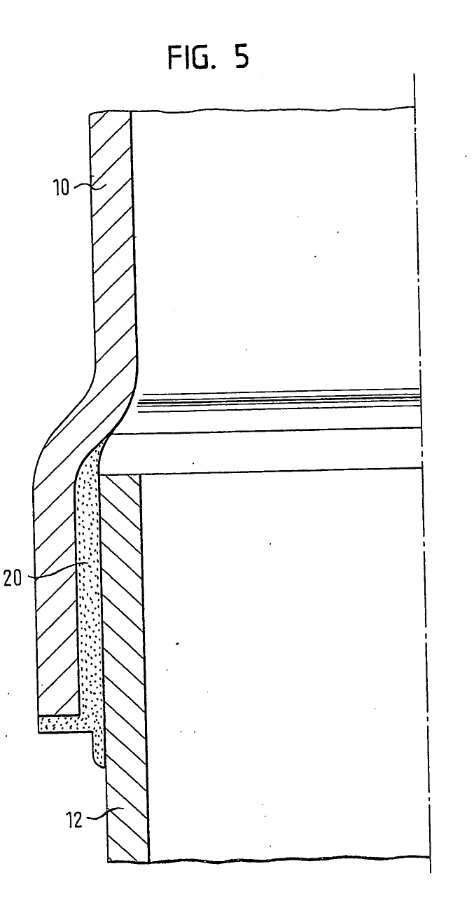

FIG. 5 shows on an enlarged scale the detail V of FIG. 4;

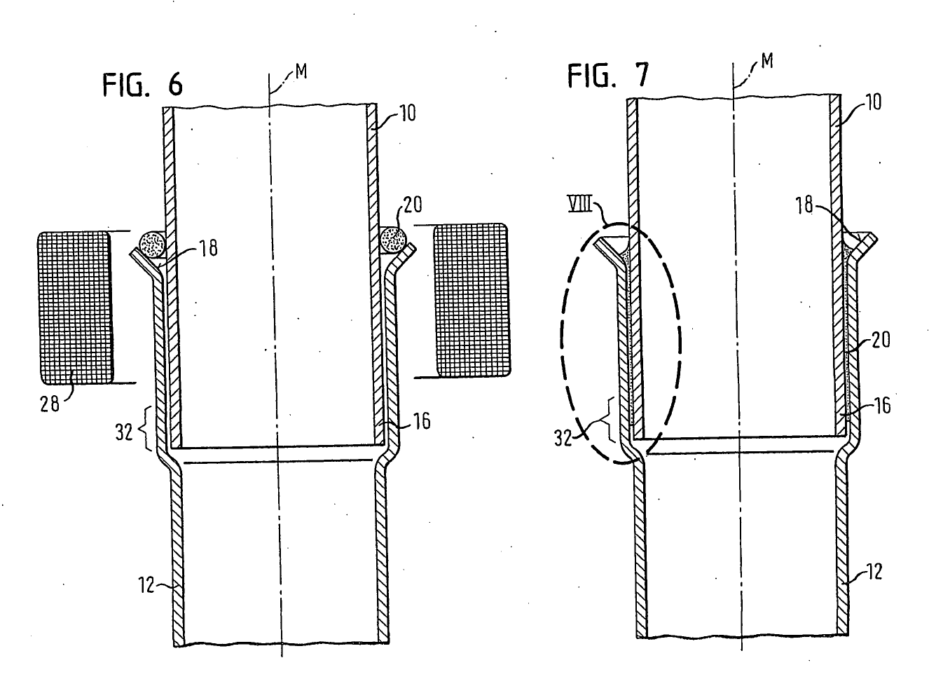

FIG. 6 schematically shows according to a third embodiment of the invention two components which are to be soldered to each other;

FIG. 7 shows the two components of FIG. 6 in the soldered state;

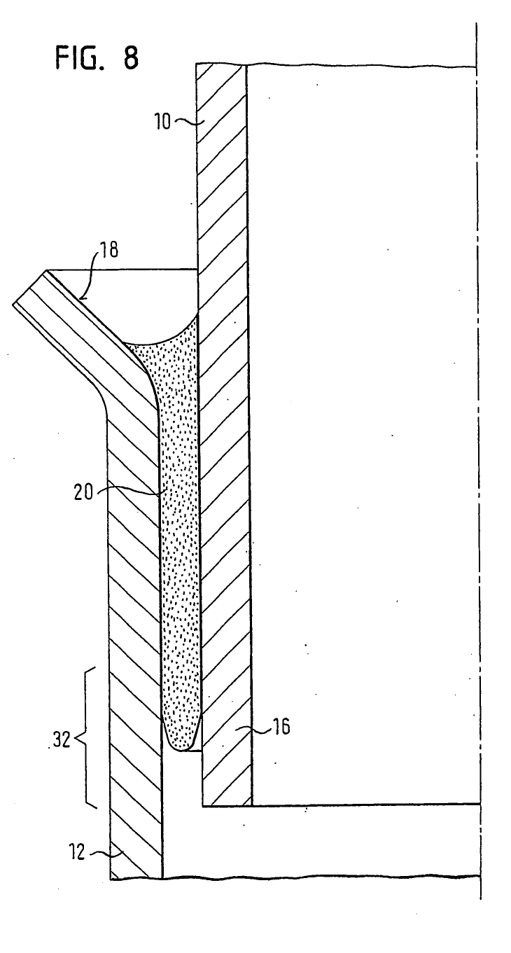

FIG. 8 shows on an enlarged scale the detail VIII of FIG. 7;

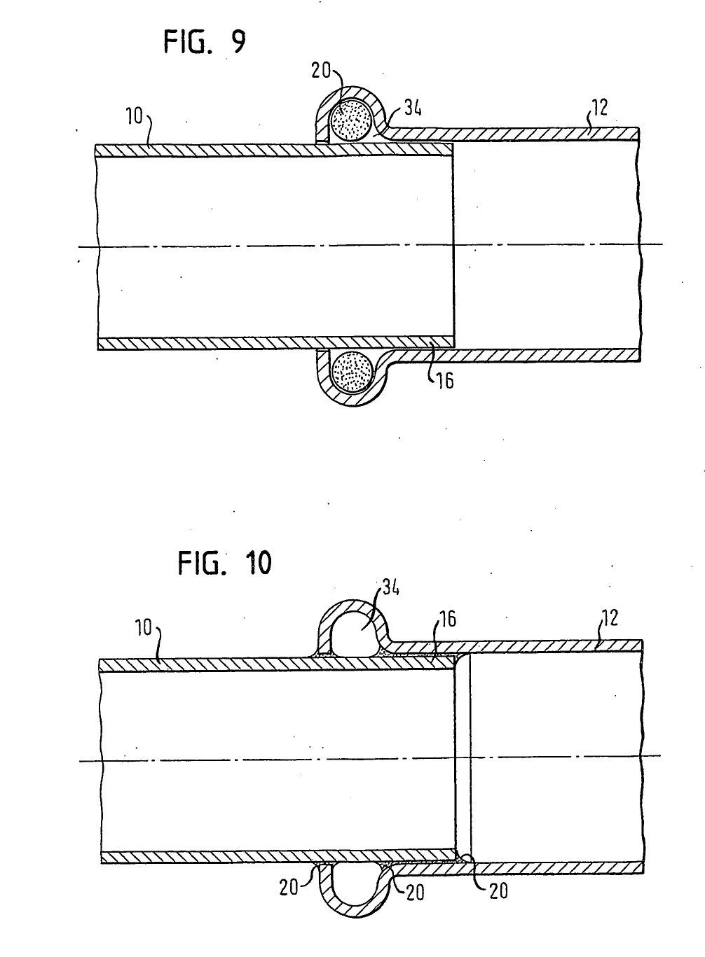

FIG. 9 schematically shows according to a fourth embodiment two components which are to be soldered to each other;

FIG. 10 shows the components of FIG. 9 in the soldered state;

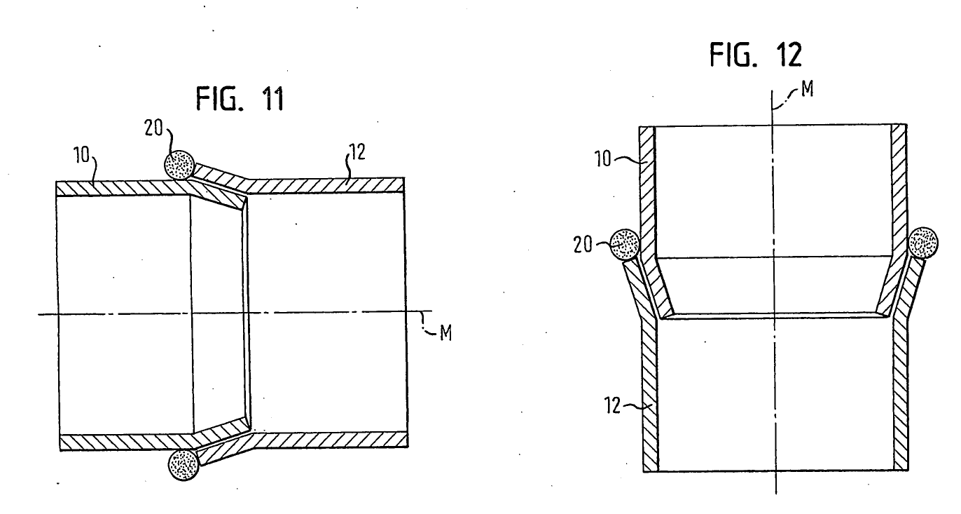

FIG. 11 schematically shows according to a fifth embodiment two components which are to be soldered to each other;

FIG. 12 shows the components of FIG. 11 in another position during soldering; and

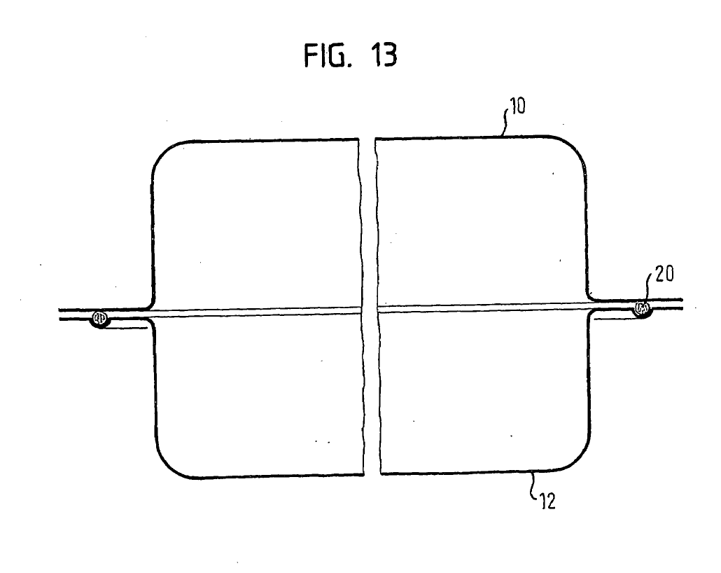

FIG. 13 schematically shows according to a sixth embodiment two components which are to be soldered to each other.

FIG. 1 shows two components 10, 12 which in this case are two pipes of an exhaust gas system for motor vehicles. At this point it is referred to the fact that components other than pipes basically can be connected to each other, too, for instance funnels with pipes, funnels with housings etc.

The first component 10 is configured so as to have a constant cross-section, while the end of the second component 12 facing the first component 10 is configured with a bead 14 facing outwards, and adjacent to the bead 14 with an inserting portion 16. The inserting portion 16 has an outer diameter which is slightly smaller than the inner diameter of the first component 10.

The area of the bead 14, facing the component 10 and aligned perpendicular to the middle axis M, forms a support surface 18 on which a ring of solder material 20 is arranged. Thus, the solder material lies in the region of a solder gap which is formed between the inserting portion 16 of the second component 12 and the first component 10. The solder material 20 is a high temperature solder on a copper or nickel basis.

Although a solder ring is shown in the embodiments, the solder can, of course, be provided in other form, for instance as a sheet metal strip, paste etc.

Arranged around the region, to be soldered, of the two components 10, 12 is a soldering device 22 which essentially consists of two shells 24, 26 which enclose the region to be soldered in a virtually gas-tight manner. A shielding gas atmosphere within the shells 24, 26 can be produced by a suitable (not shown) device. An inductor 28 extends around the two shells 24, 26, which inductor generates eddy currents in the region of the portions, to be soldered to each other, of the two components 10, 12 as well as in the solder material 20; due to the electric resistance these eddy currents are converted into heat.

For soldering the two components 10, 12 to each other, the ring of solder material 20 is arranged on the bead 14 of the second component 12 in a first step. Then the second component 12 is inserted with the inserting portion 16 into the first component 10. Subsequently the two shells 24, 26 are closed around the portion of the two components 10, 12 which is to be soldered, and a shielding gas atmosphere is developed in the interior of the two shells. Then the portions, to be soldered, of the two components 10, 12 as well as the solder material 20 will be heated up by means of the inductor 28 to a temperature in the range of 1000° C. In this process, the solder material 20 melts, so that it will be drawn by capillary forces and against gravity into the solder gap between the two components 10, 12 and completely fills it. This can be seen in FIG. 2. The support surface 18 on the bead 14 ensures that the solder material 20 when melting does not flow downward away from the solder gap, but will be drawn into the solder gap. As an alternative, the soldering process could also be performed in a horizontal or oblique orientation.

When the two components 10, 12 are cooled off so far that a scaling in air will not occur any more, the two shells 24, 26 can be opened and the components which now are connected with each other can be removed. The soldering device is ready for receiving the next components. The particular advantage of the soldering device and of the induction soldering method performed with it lies in the fact that very short processing times are possible. The achievable processing time for the welding of two components including heating and cooling lies in the range of 40 seconds, and in fact—in contrast to welding—independent of the seam length. Consequently, a high output can be achieved with a small space requirement.

FIG. 3 to 5 show a second embodiment. For the components known from the first embodiment the same reference numerals will be used, and in this respect reference is made to the above explanations.

The difference to the first embodiment is that the support surface 18 is not formed on one of the components itself, but on a solder support 30 which here is formed as a closed ring. The solder support is made of a material which is electrically non-conductive, for instance a ceramic material, and encloses the second component 12 adjacent to the solder gap. In other words, the first component 10 is slid on the second component 12 until it rests against the solder support 30. This allows to use the solder support 30 as a reference for the positioning of the two components 10, 12 relative to each other. The face of the solder support 30 facing the first component 10 forms the support surface 18 on which the ring of solder material 20 will be arranged. It is possible to provide corrugations, projections or grooves on the solder support, when it is configured as a closed ring, which make it easier for the solder to flow underneath the end face of the component 10 into the solder gap.

The region of the two components 10, 12 which is to be soldered is heated like in the first embodiment by the soldering device (not illustrated here), so that the solder material 20 melts and is drawn into the solder gap between the two components 10, 12 (see FIGS. 4 and 5). In this process, a small part of the solder material flows past the solder support 30 in downward direction. As the solder support 30 consists of an electrically non-conductive material, however, it will not be heated by the inductor 28, so that the solder solidifies in this region. This is why only a very small part of the solder material is not available for the actual soldered connection. In FIG. 5 the soldered connection between the two components 10, 12 can be seen, after the solder support 30 has been removed. This can be done without any problems, because during soldering the solder support 30 is not heated up so far that the soldering temperature is reached. The solder material 20 accordingly does not get bonded to the surface of the solder support. The “impression” of the solder support 30 can be seen clearly.

FIG. 6 to 8 show a third embodiment. Even here, the same reference numerals are used for those components which are known from the preceding embodiments.

The difference to the first embodiment lies in the fact that in the third embodiment the support surface 18 is formed on an end portion, of the second component 10, which is expanded in the manner of a funnel. Thus, the ring of solder material 20 lies directly between the first component 10 and the second component 12. A further difference lies in the fact that the solder gap between the first and second components 10, 12 is configured such that a runout region 32 for the liquid solder material is formed. The runout region is defined in that it lies outside the region of the two components 10, 12 which is heated up by the inductor 28; thereby it will remain at a temperature, which is less than the solidification temperature of the solder material 20, even during the actual soldering operation.

When the two components 10, 12 are soldered to each other, the region of the solder gap is heated by the inductor. As soon as the solder material 20 is molten, it will be drawn by the capillary forces into the solder gap in which it wets the surface area of the two components 10, 12. As soon as the solder material reaches the lower portion of the solder gap with respect to FIG. 7, it escapes from the actual solder gap and enters the runout region 32. As the latter has a temperature which is lower than the solidification temperature of the solder material 20, the solder material solidifies in the runout region 32. The runout region 32 is chosen so as to have a sufficient length in order to prevent that the solder material escapes on the lower side of the solder gap and enters the interior of the two components 10, 12. In FIG. 8 one can see that the solder material 20 does not wet the surface area of the two components 10, 12 in the runout region 32, because they have a comparably low temperature. According to this, the end face of the solder material 20 is not concave, as can be seen at the upper end of the solder gap, but convex.

FIGS. 9 and 10 show a fourth embodiment of the invention. The difference to the preceding embodiments lies in the fact that a receiving chamber 34 is provided here, within which the solder material 20 is arranged. Unlike the preceding embodiments the solder material 20 in this case does not have to be arranged as a completely surrounding ring. It is sufficient that the solder material extends, for instance, only around the half of the circumference of the annular receiving chamber 34. As soon as the solder has melted, it will be spread along the entire circumference of the solder gap due to the capillary forces, so that a surrounding and gas-tight connection between the two components is established.

When the region of the components 10, 12, which are to be soldered to each other, is heated up to a temperature above the melting temperature of the solder material 20, the solder material which will be liquid at this time is drawn into the gap between the two components 10, 12 by capillary forces. Two distinct solder joints are formed in this process, namely a first solder joint between the end face of the second component 12 and the outer side of the first component 10, i.e. related to FIG. 10 on the left side of the receiving chamber, and a second solder joint between the inserting portion 16 of the first component 10 and the second component 12.

FIG. 11 shows a fifth embodiment of the invention. The difference to the preceding embodiments lies in the fact that the first component 10 has its end provided with a constriction in the shape of a truncated cone, whereas the second component has its end provided with a funnel-shaped flaring. The constriction of the first component is arranged in the flaring of the second component. The solder material 20 directly rests against the end face of the flaring of the second component 12. As soon as the solder material melts, it will be drawn into the solder gap by the capillary forces, so that a uniform connection between the first and second components will be obtained.

FIG. 12 shows the components known from FIG. 11, but unlike FIG. 11 the longitudinal axis of the two components 10, 12 is arranged vertically instead of horizontally. Hence, the end face of the flaring of the second component 12 serves as the support surface 18 for the solder material 20.

FIG. 13 shows a sixth embodiment. The difference to the preceding embodiments is that there are no pipes which are soldered to each other, but two housing parts of a silencer, a catalytic converter or other constituent of an exhaust gas system. The first component 10 forms the upper shell of the housing, and the second component 12 forms the lower shell of the housing. Both components are provided with a surrounding rim, with the rim of the second component being provided with a surrounding bead, so that in combination with the rim of the first component a chamber for receiving the solder material 20 is formed.

The rims of the first and second components 10, 12 as well as the solder material 20 are inductively heated, so that the solder material melts and the two components are connected with each other. It is remarkable here that even with this type of components with a very large seam length the processing time is not increased; in case the two components would be welded to each other, this would result in a processing time of several minutes because of the large seam length.

In principle, all components of an exhaust gas system can be connected with each other with the method according to the invention. In this respect it is of no significance whether the components are soldered to each other in succession, simultaneously in groups or all of them at the same time. It is also possible to solder different materials to each other. It is possible, for example, to solder tail pipes—which consist of non-ferrous metals and, with this, of a material different from that of the actual exhaust gas pipes—to the exhaust pipes.

1.-18. (canceled)

19. An exhaust gas system comprising a first component, a second component, and an induction solder joint comprising high temperature solder material positioned between the first and second components.

20. The exhaust gas system according to claim 19, wherein the first and second components are connected with each other through a push fit connection.

21. The exhaust gas system according to claim 19, wherein at least one of the first and second components is a pipe.

22. The exhaust gas system according to claim 19, wherein at least one of the first and second components has a support surface for a solder ring.

23. The exhaust gas system according to claim 22, wherein the support surface is formed by a surrounding bead.

24. The exhaust gas system according to claim 22, wherein the component having the support surface is received within the other component.

25. The exhaust gas system according to claim 19, wherein a runout region is provided between the two components which receives excessive solder that has not made a connection with the two components.

26. The exhaust gas system according to claim 19, wherein at least one of the first and second components is provided with a surrounding receiving chamber for solder material.

27. The exhaust gas system according to claim 26, wherein the receiving chamber is formed by a bead.

28. A method of connecting a first component of an exhaust gas system with a second component, in particular for a vehicular exhaust gas system, comprising the steps of:
positioning a high temperature solder material between the two components,
heating up the solder material with an inductor to a temperature which lies above the melting temperature of the solder material.

29. The method according to claim 28, wherein the solder material is arranged on a support surface.

30. The method according to claim 29, wherein a solder support is arranged in the region of the solder joint, which solder support comprises the support surface for the solder material.

31. The method according to claim 30, wherein the solder support consists of a material which is electrically non-conductive.

32. The method according to claim 31, wherein the solder support consists of a ceramic material.

33. The method according to claim 30, wherein the solder support is arranged underneath the solder joint.

34. The method according to claim 28, wherein the amount of the solder material is matched with the solder gap between the two components such that the solder material completely fills out the solder gap and excessive solder materials is received in a runout region.

35. The method according to claim 28, wherein a nickel base solder is used as solder material.

36. The method according to claim 28, wherein a copper base solder is used as solder material.
